(19) United States
(12) Patent Application Publication
(10) Pub. No.: US 2005/0145122 A1
(43) Pub. Date: Jul. 7, 2005

(54) Use of a UV-curable thermal ribbon in conjunction with a porous substrate to form a durable, on-demand electro-chemical stencil

(76) Inventors: Matthew Adams, Mason, OH (US); Glenn Aspenns, Cincinnati, OH (US)

Correspondence Address: ORUM & ROTH, 53 W. JACKSON BLVD, CHICAGO, IL, 60604, US

(21) Appl. No.: 10/950,055

(22) Filed: Sep. 24, 2004

Related U.S. Application Data
(60) Provisional application No. 60/505,668, filed on Sep. 24, 2003.

(51) Int. Cl. B41L 13/00

(52) U.S. Cl. 101/127

(57) ABSTRACT

An ink stencil having a cross-linked ink layer that provides resistance to the etching process. An ink stencil is printed on-demand using a thermal ribbon doped with UV photo inhibitors. Upon exposure to certain UV wavelengths a cross-linked structure is formed which is stronger than existing ink layers. The stencil can be used multiple times without degredation and to withstand higher power during an etching process.

This application claims the benefit of U.S. Provisional Application 60505668 entitled Use of a UV-Curable Thermal Ribbon in Conjunction with a Porous Substrate to Form a Durable, On-Demand Electro-Chemical Stencil filed Sep. 24, 2003.

### BACKGROUND OF THE INVENTION

1. Field of the Invention

The present invention relates to on-demand electro-chemical stencils. More particularly, it relates to a durable on-demand stencil printed with a UV curable thermal ribbon.

2. Description of Related Art

At this time, there are two choices for stencils requiring artwork. The first choice is to order the stencils from an electro-chemical marking company. Although these stencils provide a means to mark multiple times with a single stencil, they are expensive, the ordering process is time-consuming, and the solution does not provide the customer the opportunity to make changes to the stencil configuration as needed without placing additional orders. The second option is to use on-demand stencils. However, these stencils can only survive a single marking process. These stencils are somewhat fragile and they can only be used once during the marking process before the integrity of the stencil is breached.

The existing on-demand stencil cannot survive more than a single marking process because the ink layer is damaged as a result of the process. This limits the functionality of the stencil to a single use—increasing the cost of the stencil (one use versus several uses).

There is a need for a stencil with an ink layer that is significantly more robust than the existing ink layer to provide resistance to the etching process, thus increasing the life span of the stencil.

Existing on-demand stencils cannot be used to mark those metals requiring high-powered exposures as existing stencils cannot withstand high power exposure. Further, existing on-demand stencils cannot be used with a deep etching process because the deep etching process destroys the integrity of the ink layer causing a defective mark to be made on the metal surface.

The major failure mode of existing stencils is cracking. Cracking provides a failure point on the stencil and results in the marking of the part where it is not desirable.

### BRIEF SUMMARY OF THE INVENTION

This invention uses special ink chemistry within the thermal ribbon doped with UV photo-initiators. Upon exposure to certain UV wavelengths a cross-linked structure is formed. This cross-linked structure is stronger than the existing ink layer and survives multiple etching processes before being damaged.

There is a need for a customizable on-demand stencil that is robust enough to be used several times before the integrity of the stencil is breached.

This new stencil provides a cross-linked ink layer that is significantly more robust than the existing ink layer. This additional strength provides resistance to the etching process, thus increasing the life span of the stencil.

There is a need for a customizable stencil that is able to withstand higher power exposures and is able to be used in a deep etching process.

By using a UV curable ink system as part of the construction, three additional benefits can be derived from a more durable UV cross-linked ink layer. First, the stencil can be used multiple times without degradation making it useful for applications requiring static information to be marked onto the metal object. Second, the stencil is able to withstand higher power exposure, providing a means to mark those metals requiring high power exposures to mark (something the existing stencil cannot accomplish). Third, the stencil is able to endure the stress imparted by a deep etching process without causing a defective mark to be made onto the metal surface.

This invention provides the customer a means to manufacture durable stencils that are fully customizable without the need to place custom orders for stencils. The customer can save time and money while gaining a level of control over their stencil selection that currently does not exist.

### BRIEF DESCRIPTION OF THE FIGURES

FIG. 1 is a stencil.

FIG. 2 is a method of preparing a stencil.

FIG. 3 is an assembly for printing the inventive stencil.

### DETAILED DESCRIPTION OF THE INVENTION

This inventive stencil 10 uses special ink chemistry within the thermal ribbon. The ink 12 is doped with UV photo-initiators, that upon exposure to certain UV wavelengths form a cross-linked structure. This cross-linked structure is stronger than the existing ink layer and can survive multiple etching processes before being damaged.

The stencil 10 provides a cross-linked ink layer 12 that is significantly more robust than the existing ink layer. This additional strength provides resistance to the etching process, thus increasing the life span of the stencil.

By using a UV curable ink system as part of the construction, three additional benefits can be derived from a more durable UV cross-linked ink layer. First, the stencil 10 can be used multiple times without degradation. Second, the stencil 10 is able to withstand higher power exposure, thus providing a means to mark those metals requiring high power exposures to mark. Third, the stencil 10 is able to endure the stress imparted by the deep etching process without resulting in a defective mark being made on the metal surface.

This invention provides the customer a means to manufacture durable stencils 10 that are fully customizable without the need to place custom orders for stencils. The customer can save time and money while gaining a level of control over their stencil selection that the currently do not have.

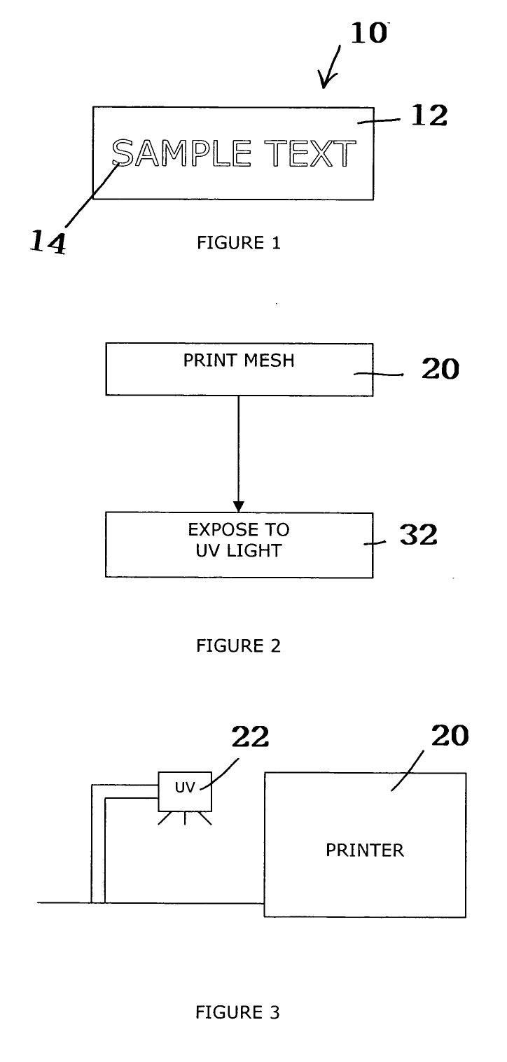

The inventive construction consists of a mesh material 14 constructed of polyester, nylon, polyethylene, or similar materials that is woven into a cloth-like fabric. Preferably, the thread count of the mesh 14 is between about 150 to about 465 threads per inch. The mesh 14 is fed through a thermal printer 30 and a wax/resin composite or ink 12 is deposited onto the surface of the substrate in a reverse manner as shown in FIG. 1.

The ink 12 acts a barrier to the etching chemical. The areas where no ink has been deposited 14 are areas 14 where the etching solution can pass through the mesh 14 and etch the surface of an object (not shown). This construction provides a means of producing on-demand stencils 10 for this chemical etching process.

The ink layer 12 is saturated with photo-initiators that, upon exposure 32 to a UV light source, begin a chemical reaction within the ink layer 12 that results in the internal bonding of the ink molecules to one another. This bonding produces an ink layer 12 that was one solid piece rather than a conglomerate of lower-molecular components. This additional strength provides supplementary resistance to cracking.

The inventive stencil, once printed, must be exposed 32 to a UV light source. This light source 22 could be attached to the front (out-bound) side of the printer 20 so that upon exiting the printer, the UV lamp 22 irradiates the printed stencil construction. The stencil 10 could also be exposed to the proper UV light source using a hand-activated lamp placed against the tabletop or a UV drawer compartment that shields the user from the UV wavelengths.

Another embodiment would involve the use of a UV sensitive substrate or mesh that when exposed to the UV light source would cross-link the UV-curable ink layer with the porous substrate as well. By doing so, the mechanical strength of the stencil would increase, continuing to improve the durability of the stencil.

1. A stencil comprising:
a mesh material,
an ink layer printed on the mesh material,
said ink layer comprises a solid piece.

2. The stencil of claim 1 wherein ink molecules in the ink layer are bonded to one another.

3. The stencil of claim 1 wherein the mesh material is a woven material.

4. The stencil of claim 3 wherein the mesh material is selected from the group consisting of polyester, nylon and polyethylene.

5. The stencil of claim 1 wherein the mesh material has a thread count between about 150 to about 465 threads per inch.

6. The stencil of claim 1 wherein the ink is doped with UV photo initiators.

7. The stencil of claim 1 wherein the ink is a wax resin composite.

8. The stencil of claim 2 wherein the ink molecules are bonded to the mesh.

9. A method of manufacturing a stencil comprising the steps of:
printing an ink indicia on a porous mesh using an ink doped with UV photo initiators,
exposing the indicia to a UV light source,
irradiating the indicia,
bonding the ink molecules to one another.

10. The method of claim 9 comprising the further step of beginning a chemical reaction that results in the bonding of the ink molecules.

11. The method of claim 9 further comprising the step of shielding a user from the UV light.

12. The method of claim 9 further comprising the step of selecting the desired indicia prior to printing.

13. The method of claim 12 wherein the ink indicia is reverse printed.

14. The method of claim 1 further comprising the step of selecting the desired indicia prior to printing.

15. The method of claim 14 further comprising the step of shielding a user from the UV light.

16. A method of chemical etching using a stencil comprising the steps of:
selecting a desired indicia,
reverse printing the indicia on a porous mesh using an ink doped with UV initiators,
exposing the indicia to a UV light source,
irradiating the indicia,
bonding the ink molecules together,
applying the stencil to a first metal piece to be marked,
applying an etching solution to the first piece through the stencil,
applying a current to the first piece, and
removing the stencil.

17. The method of claim 16 comprising the further steps of:
applying the stencil to a second metal piece to be marked,
applying an etching solution to the second piece through the stencil,
applying a current to the second piece and removing the stencil, and
removing the stencil.

18. The method of claim 16 wherein the etch process is a deep etch process.

19. The method of claim 16 wherein the current is a high power current.

20. The method of claim 17 wherein the etch process is a deep etch process.
